(19) United States
(12) Patent Application Publication
(10) Pub. No.: US 2009/0107360 A1
(43) Pub. Date: Apr. 30, 2009

(54) Cationic crosslinked starch containing compositions and use thereof

(75) Inventors: Kevin R. Anderson, Cedar Rapids, IA (US); David E. Garlie, Eau Claire, WI (US)

Correspondence Address: PERKINS COIE LLP;PATENT-SEA, P.O. BOX 1247, SEATTLE, WA, 98111-1247, US

(73) Assignee: Cargill, Incorporated, Wayzata, MN (US)

(21) Appl. No.: 11/912,990

(22) PCT Filed: May 16, 2006
(86) PCT No.: PCT/US06/18881

§ 371 Date: Apr. 11, 2008

Related U.S. Application Data
(63) Continuation-in-part of application No. 11/130,381, filed on May 16, 2005, now abandoned.

(51) Int. Cl. C09D 103/04; C08B 30/00; C09D 101/08; C08B 30/02

(52) U.S. Cl. 106/162.9; 127/32; 127/65; 106/206.1

(57) ABSTRACT

There is disclosed a cationic crosslinked starch composition comprising at least one cationic crosslinked waxy starch and another starch. There is also disclosed paper products comprising the starch composition. The paper products are generally characterized by having improved internal bond strength. The use of the starch blends in the papermaking process results generally in improved paper furnish drainage and retention properties. Also disclosed are coating formulations containing the starch compositions of the present disclosure. Also disclosed are processes for producing the compositions.

### FIELD OF THE DISCLOSURE

The present invention is directed to novel cationic crosslinked starch comprising compositions and the use thereof.

### BACKGROUND

It is well known that compositions of starches have been used in the production of various products as additives. For example, compositions of starches have been used in the production of paper products for purposes of economy, for sizing, and other purposes. It would therefore be desirable to provide new cationic crosslinked starch comprising compositions that will be useful in preparing various products. In particular, the use of the new cationic crosslinked starch comprising compositions will improve the retention and drainage properties of the papermaking process, and would be expected to improve the strength of the resultant paper product. Furthermore, it is expected that use of the new cationic crosslinked starch comprising compositions will be useful in the preparation of coating compositions and paint compositions.

### SUMMARY OF THE DISCLOSURE

The present disclosure is directed to cationic crosslinked starch comprising compositions, and the use thereof in the preparation of cellulosic webs such as paper products, coating compositions, and paints. The starch compositions comprise from about 0.01 to about 99.99 weight percent of at least one cationic crosslinked starch, based upon total starch weight, and from about 0.01 to about 99.99 weight percent of at least one other starch, based upon total starch weight. The present invention is also directed to cellulosic webs, such as paper products, coating compositions, and paints, that are produced utilizing the starch compositions described herein.

### DETAILED DESCRIPTION OF THE DISCLOSURE

The present disclosure is directed to cationic crosslinked starch comprising compositions, and the use thereof in the preparation of cellulosic webs such as paper products, coating compositions, and paints. The starch compositions comprise from about 0.01 to about 99.99 weight percent of at least one cationic crosslinked starch, based upon total starch weight, and from about 0.01 to about 99.99 weight percent of at least one other starch, based upon total starch weight. The starch compositions of the present disclosure are not inclusive of naturally occurring impurities, residual or otherwise. The present invention is also directed to cellulosic webs, such as paper products, coating compositions, and paints, that are produced utilizing the starch compositions described herein.

The starch compositions of the present disclosure in another embodiment comprise from about 5 to about 95 percent by weight cationic crosslinked starch and from about 5 to about 95 weight percent of at least one other starch. In another embodiment, the starch compositions comprise from about 10 to about 90 percent by weight cationic crosslinked starch and from about 10 to about 90 percent by weight of at least one other starch. In a preferred embodiment, the starch compositions comprise from about 10 to about 50 percent by weight cationic crosslinked starch and from about 50 to about 90 percent by weight of at least one other starch.

In another embodiment of the present disclosure where the components of the composition comprise at least two cationic crosslinked starches, the amounts of the cationic crosslinked starches may be as follows. A first of the cationic crosslinked starches is present in an amount ranging from about 0.01 to 95 weight percent based on the composition, and a second of the cationic crosslinked starches is present in an amount ranging from 5 weight percent to about 99.99 weight percent of the composition. In this embodiment, preferably, the starch compositions comprise from about 10 to about 90 percent by weight a first cationic crosslinked starch and from about 10 to about 90 percent by weight a second cationic crosslinked starch.

In the present compositions, there may be utilized any cationic crosslinked starch. The starch may be derived from any suitable source such as dent corn starch, waxy corn starch, potato starch, wheat starch, rice starch, sago starch, tapioca starch, sorghum starch, sweet potato starch, and mixtures thereof.

In the compositions of the present disclosure, there is utilized at least one, or more, cationic crosslinked starch. In producing the cationic crosslinked starch, any conventional method may be used such as the following. A starch, as described herein, is cationized by reacting the starch with any cationizing agent. Exemplary of the cationizing agents are reagents having amino ions, imino ions, sulfonium ions, phosphonium ions, or ammonium ions and mixtures thereof. The cationizing reaction may be carried out in any conventional manner such as reacting the starch in an aqueous slurry form with the cationizing reagent, usually in the presence of an activating agent such as sodium hydroxide. Another process that may be used is a semi-dry process where the starch is reacted with the cationizing reagent in the presence of an activating agent such as sodium hydroxide, in a limited amount of water.

Examples of preferred cationizing agents are those having an ammonium ion, and more preferably, where the ammonium ion is a quaternary ammonium ion. A particularly useful cationizing agent is (3-chloro-2-hydroxypropyl)trimethylammonium chloride.

The starch, as described herein, is crosslinked by reacting the starch with any crosslinking agent. The reaction is carried out using any known manner for crosslinking a product. The crosslinking component, suitable for use herein, includes, but is not limited to, a multi-functional etherifying agent, a multi-functional esterifying agent, mixtures thereof, and the like. Specific examples of suitable crosslinking agents include, but are not limited to, epichlorohydrin, a dicarboxylic acid, phosphorous oxychloride, an alkali earth metal salt of trimetaphosphate, a phosphorous oxyanhydride that is a metal salt of a linear polyphosphate, a linear mixed anhydride, a polyamine polyepoxide resin, mixtures thereof, and the like. The crosslinking reaction may be carried out in any conventional manner such as reacting the starch in an aqueous slurry form with the crosslinking reagent usually in the presence of an activating agent such as sodium hydroxide. Another crosslinking process that may be used is a semi-dry process where the starch is reacted with the crosslinking reagent in the presence of an activating agent such as sodium hydroxide, in a limited amount of water.

The starch may be cationized and crosslinked in any order, in producing the cationic crosslinked starch. The cationizing agent and the crosslinking agent may be utilized in any order, including simultaneously.

The compositions of the present disclosure comprise a cationic crosslinked starch and at least one other starch. The at least one other starch may be any starch other than the specific cationic crosslinked starch utilized in the composition.

The at least one other starch may be derived from any suitable source such as dent corn starch, waxy corn starch, potato starch, wheat starch, rice starch, sago starch, tapioca starch, sorghum starch, sweet potato starch, and mixtures thereof.

In more detail, the at least one other starch may be an unmodified starch, or a starch that has been modified by a chemical, physical, or enzymatic modification.

Chemical modification includes any treatment of a starch with a chemical that results in a modified starch. Within chemical modification are included, but not limited to, depolymerization of a starch, oxidation of a starch, reduction of a starch, etherification of a starch, esterification of a starch, nitrification of a starch, defatting of a starch, and the like. Chemically modified starches may also be prepared by using a combination of any of the chemical treatments. Examples of chemically modified starches include the reaction of octenyl succinic anhydride with starch to produce a hydrophobic esterified starch; the reaction of 2,3-epoxypropyltrimethylammonium chloride with starch to produce a cationic starch; the reaction of ethylene oxide with starch to produce hydroxyethyl starch; the reaction of hypochlorite with starch to produce an oxidized starch; the reaction of an acid with starch to produce an acid depolymerized starch; defatting of a starch with a solvent such as methanol, ethanol, propanol, methylene chloride, chloroform, carbon tetrachloride, and the like, to produce a defatted starch.

Physically modified starches are any starches that are physically treated in any manner to provide physically modified starches. Within physical modification are included, but not limited to, thermal treatment of the starch in the presence of water, thermal treatment of the starch in the absence of water, fracturing the starch granule by any mechanical means, pressure treatment of starch to melt the starch granules, and the like. Physically modified starches may also be prepared by using a combination of any of the physical treatments. Examples of physically modified starches include the thermal treatment of starch in an aqueous environment to cause the starch granules to swell without granule rupture; the thermal treatment of anhydrous starch granules to cause polymer rearrangement; fragmentation of the starch granules by mechanical disintegration; and pressure treatment of starch granules by means of an extruder to cause melting of the starch granules.

Enzymatically modified starches are any starches that are enzymatically treated in any manner to provide enzymatically modified starches. Within enzymatic modification are included, but not limited to, the reaction of an alpha amylase with starch, the reaction of a protease with starch, the reaction of a lipase with starch, the reaction of a phosphorylase with starch, the reaction of an oxidase with starch, and the like. Enzymatically modified starches may be prepared by using a combination of any of the enzymatic treatments. Examples of enzymatic modification of starch include the reaction of alpha-amylase enzyme with starch to produce a depolymerized starch; the reaction of alpha amylase debranching enzyme with starch to produce a debranched starch; the reaction of a protease enzyme with starch to produce a starch with reduced protein content; the reaction of a lipase enzyme with starch to produce a starch with reduced lipid content; the reaction of a phosphorylase enzyme with starch to produce an enzyme modified phosphated starch; and the reaction of an oxidase enzyme with starch to produce an enzyme oxidized starch.

Furthermore, the at least one other starch may include a hydrophobic starch, a cationic starch, a crosslinked starch, a cationic crosslinked starch, an oxidized starch, a hydroxyalkylated starch, an esterified starch, a grafted starch interpolymer, or mixtures thereof.

The hydrophobic starch may be any hydrophobic starch. This includes any starch that is modified in any known manner to render the starch hydrophobic. The term, hydrophobic starch, as used herein, is defined as any starch that will absorb water to an extent less than that of the starch material that has not been rendered hydrophobic.

For example, a suitable method for preparing a hydrophobic starch is as follows. The starch to be rendered hydrophobic may be any starch. The starch can be modified by introducing a functional group that renders the starch hydrophobic, such as an amine, an ester, or an ether. Alternatively, the starch may be chemically, physically, or enzymatically treated prior to rendering the starch hydrophobic. Furthermore, a hydrophobic starch may be prepared by introducing any functional group such as an amine, an ester, or an ether, to any starch, prior or subsequent to rendering the starch hydrophobic.

In more detail, in rendering a starch hydrophobic, any known manner may be utilized. For example, the starch may be esterified or etherified, or the like, to achieve hydrophobicity. Suitable for use as modifying agents to render starches hydrophobic are, but not limited to, an aryl-, alkyl-, alkenyl-, aralkyl-, aralkenyl-anhydride; an aryl-, alkyl-, alkenyl-, aralkyl-, aralkenyl-halogen; an aryl-, alkyl-, alkenyl-, aralkyl-, aralkenyl- ketene dimer; an aryl-, alkyl-, alkenyl-, aralkyl-, aralkenyl-epoxide; an aryl-, alkyl-, alkenyl-, aralkyl-, aralkenyl-ester and acid halide derivatives of carboxylic acids, intramolecular combinations thereof, and mixtures thereof. Preferred modifying agents for rendering the starches hydrophobic are alkenyl succinic anhydrides, particularly octenyl succinic anhydride. Grafted starch interpolymers are also suitable hydrophobic starches.

The cationic starch used in the starch compositions of the present disclosure may be any cationic starch. A starch of any source may be used as the starch that is rendered cationic. Cationic starches may be produced by any conventional manner. For example, the cationic starches may be produced by a chemical reaction of the starch with a modifying agent containing an amino, imino, ammonium, sulfonium, or phosphonium group. The chemical reaction may be an esterification or etherification reaction. Preferred for use are the primary, secondary, tertiary or quaternary amino groups, with the tertiary amino and quaternary ammonium starch ethers, such as the quaternary amino alkyl ether of starch, more preferred. If desired, the cationic starch may be treated in any conventional manner with known treating agents to render the cationic starches hydrophobic.

The oxidized starch used in the starch compositions of the present disclosure may be any oxidized starch. Oxidized starch may be produced in any conventional manner by the reaction of any starch with any oxidizing agent. Examples of suitable oxidizing agents include metal salts of hypochlorite, metal salts of permanganate, hydrogen peroxide, organic peroxides, peracids, and the like, and mixtures thereof. For example, dent corn starch may be reacted with sodium hypochlorite solution under alkaline pH conditions for a length of time sufficient to achieve a product suitable for use as an oxidized starch.

Hydroxyalkylated starches such as hydroxyethyl starch and hydroxypropyl starch may be produced by any conventional manner. For example, hydroxyethyl starch may be produced by the etherification of any starch with ethylene oxide. Similarly, hydroxypropyl starch may be produced by the etherification of any starch with propylene oxide. In both instances, the starch is treated with the alkylene oxide, under alkaline pH conditions, for a length of time sufficient to achieve a product suitable for use as a hydroxyalkylated starch.

Any grafted starch interpolymer may be used in the starch compositions of the present disclosure. The grafting of the starch is a chemical modification of the starch. Additionally, in preparing the grafted starch interpolymer, the starch component may be chemically, physically, and/or enzymatically modified at the time of the interpolymerization. The grafted starch interpolymer is produced using any conventional manner for interpolymerizing a starch with one or more monomers. The one or more components that is interpolymerized with the starch, may be any suitable monomer. Exemplary of suitable monomers include, but are not limited to, the following: vinyl monomers such as alkyl acrylates, hydroxylated alkyl acrylates, alkyl methacrylates, hydroxylated alkyl methacrylates, alkyl vinyl ketones, substituted acrylamides, methacrylic acid, crotonic acid, itaconic acid, fumaric acid, maleic acid, maleic anhydride, vinyl halides, vinylidene halides, vinyl esters, vinyl ethers, vinyl carbazole, N-vinyl pyrrolidone, chlorostyrene, alkyl styrene, ethylene, propylene, isobutylene, vinyl triethoxysilane, vinyl diethylmethylsilane, vinyl methyldichlorosilane, triphenyl vinylsilane, 1-vinyl-1-methylsila-14-crown-5. Also suitable for use are dienes such as, 1,3-butadiene, isoprene, chloroprene, cyclobutadiene, and divinyl benzene.

The grafted starch interpolymers may be produced utilizing any conventional manner. For example, a starch may be grafted with at least one or more monomer, in the presence of a free radical initiator. The starch utilized herein may be used in any form such as, for example, gelatinizing the starch to form a starch paste, that is thereafter reacted with at least one monomer. Any suitable temperature and/or pressure may be employed in the reaction. Any suitable ratio of the components utilized in preparing the grafted starch interpolymer may be used. Any suitable free radical initiator may be used provided that the free radical initiator acts to interpolymerize and graft the monomers. Exemplary of such initiators are organic and inorganic peroxy compounds, and azo compounds.

Any esterified starches may be produced utilizing any conventional manner. For example, any starch source may be reacted with suitable esterifying agents such as, aryl-, alkyl-, alkenyl-, aralkyl-, aralkenyl-anhydrides, aryl-, alkyl-, alkenyl-, aralkyl-, aralkenyl-ester and acid halide derivatives of carboxylic acids, intramolecular combinations thereof, and mixtures thereof. In particular, any starch source may be reacted with acetic anhydride to produce an acetylated starch product.

In an embodiment of the present disclosure, the starch composition comprises a cationic crosslinked waxy corn starch and a cationic crosslinked dent corn starch. The components may also differ by degree of cationic substitution or the level of crosslinking.

In another embodiment of the present disclosure, the composition comprises a waxy corn starch that has been cationized with a quaternary ammonium ion, and crosslinked by reaction with multi-functional esterifying agent, and a dent corn starch that has been cationized with a quaternary ammonium ion, and crosslinked by reaction with a multi-functional esterifying agent.

In another embodiment of the present disclosure, the components of the composition comprise a waxy starch that has been cationized by reaction with 2,3-epoxypropyltrimethylammonium chloride, and crosslinked by reaction with sodium trimetaphosphate, and a dent corn starch that has been cationized by reaction with 2,3-epoxypropyltrimethylammonium chloride, and crosslinked by reaction with sodium trimetaphosphate.

In another embodiment of the present disclosure, the components of the composition comprise a waxy corn starch that is cationized and crosslinked and a potato starch that is cationized. More particularly, the waxy corn starch is cationized by reaction with 2,3-epoxypropyltrimethylammonium chloride, and crosslinked by reaction with sodium trimetaphosphate, and the potato starch is cationized with 2,3-epoxypropyl-trimethylammonium chloride.

In another embodiment of the present disclosure, the components of the composition comprise a dent corn starch that is cationized and crosslinked and a potato starch that is cationized. More particularly, the dent corn starch is cationized by reaction with 2,3-epoxypropyltrimethylammonium chloride, and crosslinked by reaction with phosphorous oxychloride, and the potato starch is cationized with 2,3-epoxypropyltrimethylammonium chloride.

In another embodiment of the present disclosure, the components of the composition comprise waxy corn starch that is cationized and crosslinked and a tapioca starch that is cationized. More particularly, the waxy corn starch is cationized by reaction with 2,3-epoxypropyltrimethylammonium chloride, and crosslinked by reaction with sodium tripolyphosphate, and the tapioca starch is cationized with 2,3-epoxypropyltrimethylammonium chloride.

In another embodiment of the present disclosure, the components of the composition comprise waxy corn starch that is cationized and crosslinked and a tapioca starch that is cationized and crosslinked. More particularly, the waxy corn starch is cationized by reaction with 2,3-epoxypropyltrimethylammonium chloride, and crosslinked by reaction with sodium trimetaphosphate, and the tapioca starch is cationized with 2,3-epoxypropyltrimethylammonium chloride and crosslinked by reaction with sodium trimetaphosphate.

In another embodiment of the present disclosure, the components of the composition comprise waxy corn starch that is cationized and crosslinked and a dent corn starch that is hydroxyalkylated. More particularly, the waxy corn starch is cationized by reaction with 2,3-epoxypropyltrimethylammonium chloride, and crosslinked by reaction with sodium trimetaphosphate, and the dent corn starch is hydroxyalkylated by reaction with ethylene oxide.

In another embodiment of the present disclosure, the components of the composition comprise tapioca starch that is cationized and crosslinked and a dent corn starch that is oxidized. More particularly, the tapioca starch is cationized by reaction with 2,3-epoxypropyltrimethylammonium chloride, and crosslinked by reaction with epichlorohydrin, and the dent corn starch is oxidized by reaction with sodium hypochlorite.

In another embodiment of the present disclosure, the components of the composition comprise a waxy corn starch that is cationized and crosslinked and a tapioca starch that is rendered hydrophobic. More particularly, the waxy corn starch is cationized by reaction with 2,3-epoxypropyltrimethylammonium chloride, and crosslinked by reaction with sodium tetra-polyphosphate, and the tapioca starch is rendered hydrophobic by the reaction with n-octenyl succinic anhydride.

In another embodiment of the present disclosure, the components of the composition comprise a waxy corn starch that is cationized and crosslinked, a tapioca starch that is rendered hydrophobic, and a dent corn starch that has been oxidized. More particularly, the waxy corn starch is cationized by reaction with 2,3-epoxypropyltrimethylammonium chloride, and crosslinked by reaction with sodium tetra-polyphosphate, and the tapioca starch is rendered hydrophobic by reaction with n-octenyl succinic anhydride, and the dent corn starch is oxidized by reaction with sodium hypochlorite.

In preparing the blends of the present disclosure, the cationic crosslinked starch is utilized in an amount ranging from about 0.01 percent by weight to about 99.99 percent by weight based on the starch and more preferably from about 5 percent by weight to about 95 percent by weight, and still more preferably from about 10 percent by weight to about 90 percent by weight. The at least one other starch component of the composition is utilized in an amount ranging from about 0.01 percent by weight to about 99.99 percent by weight based on the starch, preferably about 5 percent by weight to about 95 percent by weight, and still more preferably from about 10 percent by weight to about 90 percent by weight.

In producing the starch compositions of the present disclosure, any conventional method may be used for mixing the components of the composition. For example, each of the starch components of the composition may be in dry form when mixed together. Alternately, each of the starch components of the composition may be in slurry form when mixed together to form the composition. Alternately, one of the starch components may be in dry form, and one of the starch components may be in slurry form, when the starch components are mixed together to form a starch composition. Another acceptable method of mixing is to combine the gelatinized starch pastes after the individual starch suspensions have been gelatinized by a cooking process. In another method suitable for use, any one of the starch components of the composition may be in a gelatinized starch paste form when mixed with any other starch component. As mentioned, any known method for mixing the starch components of the compositions may be utilized.

In an alternative embodiment, a starch blend of the present disclosure comprising cationic crosslinked starch components may be prepared in the following manner. Unmodified starch components are mixed to provide a composition of unmodified starch components. Thereafter, the blend of unmodified starch components is cationized and crosslinked to produce a composition of starch components, each of which is cationized and crosslinked.

For example, waxy corn is conventionally wet-milled to provide waxy corn starch slurry. Dent corn starch is added to the waxy corn starch slurry in any desired amount. Thereafter, the slurry comprising waxy corn starch and dent corn starch is cationized and crosslinked by any known manner. The cationization and crosslinking may be carried out in any order, including simultaneously. The resultant cationized crosslinked starch slurry composition is then washed and dried.

Alternatively, in another embodiment, waxy corn starch slurry and dent corn starch slurry may be individually cationized and crosslinked in any known manner as desired. The cationization and crosslinking may be carried out in any order, including simultaneously. The separate cationized crosslinked waxy corn starch and cationized crosslinked dent corn starch components may then be combined in any known manner to produce a composition of any desired ratio. More particularly, the components may be combined by, for example, mixing. The resultant cationized crosslinked starch slurry composition may then be washed and dried.

Alternatively, in another embodiment, waxy corn starch slurry and dent corn starch slurry may be individually cationized in any known manner. The separate cationized waxy corn starch slurry and the cationized dent corn starch slurry may then be combined in any known manner, to produce a composition of any desired ratio. More particularly, the components may be combined by, for example, mixing. The resultant cationized starch slurry composition comprising the cationized waxy corn starch slurry and the cationized crosslinked dent corn starch slurry, may then be crosslinked in any known manner. The resultant cationized crosslinked starch slurry composition may then be washed and dried.

Alternatively, in another embodiment, waxy corn starch slurry and dent corn starch slurry are crosslinked individually in any known manner. The separate crosslinked waxy corn starch and crosslinked dent corn starch are then combined in any known manner, to produce a composition of any desired ratio. The crosslinked starch slurry compositions are then cationized together to produce a cationic crosslinked starch slurry composition. The resultant cationized crosslinked starch slurry composition may then be washed and dried.

Alternatively, in another embodiment, rather than in slurry form as in the above three embodiments, at least one of the components of the composition may be in dry form when mixed together.

Alternatively, in another embodiment, the starch composition may be produced by combining the gelatinized starch pastes of each of the cationic crosslinked starch components. The gelatinized starch pastes are obtained by gelatinizing the individual starch components by cooking. Typically, the heating to achieve gelatinization is carried out at a temperature above about 90° C.

Alternatively, in another embodiment, the starch compositions may be produced by combining gelatinized starch paste of a cationic crosslinked starch component with ungelatinized starch slurry of another starch component.

Alternatively, in another embodiment, the starch compositions may be produced by mixing the components of the composition. Thereafter, the resultant mixture is heated to form a gelatinization paste mixture in which the starch is gelatinized at a temperature typically above about 90° C. The resultant gelatinized paste mixture is subsequently dried to remove substantially all moisture. Optionally, the dried mixture is thereafter ground to a powder. An advantage resulting from the process is that the need for gelatinizing starch at the paper production facility is removed.

Alternatively, in another embodiment, the starch compositions may be produced by forming a gelatinized starch paste of each of the components of the composition. This is achieved by heating each of the components to form a gelatinized starch paste, typically, at a temperature at about above 90° C. The resultant gelatinized paste mixture is subsequently dried to remove substantially all moisture. Optionally, the dried mixture is thereafter ground to a powder. An advantage resulting from the process is that the need for gelatinizing starch to be used in producing paper is removed.

In carrying out the above two processes the drying may be achieved in any manner. For example, there may be utilized a drum dryer, a spray dryer, a thin film wipe dryer, a turbo reactor, a fluidize bed dryer, and the like.

The starch compositions of the present disclosure may include any conventional additives. For example, there may be incorporated dyes, pigments, sizing additives, retention and drainage aids, aqueous suspensions or solutions of biopolymers or synthetic polymers, and the like.

The cationic crosslinked starch compositions of the present disclosure are useful in the production of paper. The starch compositions of the present disclosure may be incorporated in the production of paper using any conventional manner. For example, the cationic crosslinked starch compositions may be slurried in water and the resultant slurry heated at a temperature sufficient to achieve gelatinization of the starch slurry to produce a gelatinized starch paste. Typically, the heating to achieve gelatinization is carried out at a temperature above about 90° C. Alternatively, the starch components of the composition are individually heated to achieve gelatinization and the resulting starch pastes are combined to yield a gelatinized starch paste. The gelatinized starch paste achieved by either of the above techniques may then be introduced into a cellulosic suspension, particularly a paper furnish, in any known manner. In doing so, the gelatinized starch paste may be introduced at the wet-end of a paper machine in a paper fiber thick stock, or a paper fiber thin stock, or a split addition to both the thick stock and thin stock. In introducing the gelatinized starch paste to the cellulosic suspension, any amount of starch blend may be incorporated as desired. Typically, the amount of starch composition to be incorporated ranges from about 0.1% to about 5% by weight based on the paper fiber. In a preferred embodiment, the starch composition is present in an amount ranging from about 0.5% to about 2% by weight based on the weight of the fiber.

It has been found that incorporation of the starch compositions of the present disclosure in the production of paper, results in increased retention and improved drainage of the paper furnish. These properties are generally recognized in the art as being useful for enhancing the papermaking process. Furthermore, it is expected that incorporation of the starch compositions of the present disclosure in the production of paper, will result in paper products having higher internal bond strength.

In addition, the starch compositions of the present disclosure are utilized in the preparation of coatings that preferably may be applied to paper. The starch compositions of the present disclosure may be used as a binder in the production of paper coating formulations. Preferably, the starch compositions are in a gelatinized form when utilized in the preparation of the paper coatings. Typically, paper coating formulations comprise a pigment such as clay, calcium sulfate, or calcium carbonate; a binder such as latex, polyvinyl alcohol, starch, or protein; and various other additives such as lubricants, insolubilizers, rheology modifiers, optical brighteners, water retention aids, dispersants, biocides, dyes, and the like. It is expected that use of the novel starch compositions of the present disclosure in paper coatings will impart improved hydrophobicity, improved ink holdout, and improved printing properties to the coated product. Furthermore, the use of the starch compositions in coatings is expected to impart improved rheology to the coating color, and impart a bulky structure to the dried coating. Preferably, the coating is applied to a paper product. In addition, the coating of the present disclosure may be utilized as a paint.

Typically, in the production of the present coatings there is utilized a pigment in an amount of about 100 parts. The binder component of the coating is typically utilized in an amount of about 1 to about 50 parts, more typically about 5 to about 20 parts, based on the pigment. Any other ingredients such as lubricants, rheology modifiers, water retention agents, or the like, that are desired in the coating may be utilized in well known conventional amounts, such as 0.5 parts based on the pigment.

The coatings incorporating the novel starch compositions may be applied to a surface, such as that of a cellulosic web, in any conventional manner. Typically, the coating may be applied to a surface by the use of a roll coater, a rod coater, a blade coater, a film press coater, an air knife coater, a curtain coater, a spray coater, and the like.

It is expected that the cationic crosslinked starch composition of the present invention would have utility in fields other than papermaking and paints. Such applications would include, for example, food container manufacture, flocculation of aqueous suspensions as in water treatment and ore purification, and the like.

The following examples are presented to illustrate the present invention and to assist one of ordinary skill in making and using the same. The examples are not intended in any way to otherwise limit the scope of the invention.

### EXAMPLES

The following test procedures are utilized in evaluating the properties of the starch compositions and the paper products provided in the examples.

### Test Procedures

### Paper Furnish Drainage Rate

The Paper Furnish Drainage Rate analysis was performed on a Dynamic Drainage Analyzer (DDA) manufactured by AB Akribi Kemikonsulter, Hogalidsgatan 26 S-856 31 Sundsvall, Sweden. The procedure utilized in evaluating the paper furnish drainage rate performance is fully described in the manual (version 3.xx, March 2003) for operating the Dynamic Drainage Analyzer provided by the manufacturer. In carrying out the evaluation, the procedure was utilized under the following generalized conditions:
Rotor Speed—750 rpm
Vacuum Setting—225 bars
Sample Volume—800 ml
Start Rotor—45 seconds
Make starch and other additive additions as specified
Drain—at 0 seconds
Record drainage rate

### Paper Furnish Retention Value

The paper furnish retention value was performed by measuring turbidity of the filtrate generated from the Paper Furnish Drainage Rate test from above. Turbidity was measured using a Model 2100P Portable Turbidimeter Instrument, available through the HACH COMPANY, following the instructions contained in the corresponding manual for the 2100P. The filtrate sample was removed from the Dynamic Drainage Apparatus soon after the drainage rate determination and 15 ml placed in the measuring vial for the 2100P. The turbidity was measured and recorded as Nephelometric Turbidity Units (NTU). The NTU values have an inverse relationship to Paper Furnish Retention in that the lower the NTU, the better the Paper Furnish Retention.

### Internal Bond Strength

Internal Bond Strength of Paper (Scott Bond)—TAPPI Test Procedure T 541 om-89

### Starch Compositions

### Example 1

### Cationic Crosslinked Dent Starch Control

In the following examples there was utilized as a control, a cationic crosslinked dent corn starch in the form of a gelatinized starch paste for evaluation purposes. In more detail, ALTRA CHARGE 140 starch, available from Cargill, Incorporated, is a cationic crosslinked dent corn starch that has been rendered cationic by treatment of the dent starch with (3-chloro-2-hydroxypropyl)trimethylammonium chloride under alkaline conditions and thereafter crosslinked.

In producing the gelatinized starch paste, ALTRA CHARGE 140 starch was slurried to a level of 30% solids in a 1000 gallon tank. The slurry was introduced into a continuous jet cooker system. Pre-dilution water was added at a rate of 29 gallons per minute to reduce the cooking solids of the starch. The slurried ALTRA CHARGE 140 starch was jet cooked at 6.8 gallons per minute at a steam pressure of 125 psi and a temperature of 280° F. Once the starch was cooked, the resulting gelatinized starch paste was diluted to 2.0% solids by adding 60 gallons per minute of post-dilution water. The gelatinized starch paste was transferred to a 5000 gallon tank and gently agitated. The ALTRA CHARGE 140 was evaluated for the properties of drainage and retention and the results are reported in TABLE 1.

### Example 2

### Cationic Crosslinked Waxy Corn Starch Control

In the following examples there was utilized as a control, a cationic crosslinked waxy corn starch in the form of a gelatinized starch paste for evaluation purposes. In more detail, ALTRA CHARGE 340 starch, available from Cargill, Incorporated, is a cationic crosslinked waxy corn starch that has been rendered cationic by treatment of the dent starch with (3-chloro-2-hydroxypropyl)trimethylammonium chloride under alkaline conditions and thereafter crosslinked.

In producing the gelatinized starch paste, ALTRA CHARGE 340 starch was slurried to a level of 24% solids in a 1000 gallon tank. The slurry was introduced into a continuous jet cooker system. Pre-dilution water was added at a rate of 20 gallons per minute to reduce the cooking solids of the starch. The slurried ALTRA CHARGE 340 starch was jet cooked at 6.1 gallons per minute at a steam pressure of 125 psi and a temperature of 250° F. Once the starch was cooked, the resulting gelatinized starch paste solution was diluted to 2.0% solids by adding 45 gallons per minute of post-dilution water. The gelatinized starch paste solution was transferred to a 7000 gallon tank and gently agitated. The ALTRA CHARGE 340 starch was evaluated for the properties of drainage and retention and the results are reported in TABLE 1.

### Example 3

### Starch Composition Comprising 75% Cationic Crosslinked Waxy Corn Starch/25% Cationic Crosslinked Dent Corn Starch

In this example, there was provided a cationic crosslinked starch composition comprising 75% by weight ALTRA CHARGE 340 cationic crosslinked waxy corn starch and 25% by weight ALTRA CHARGE 140 cationic crosslinked dent corn starch, in the form of a gelatinized starch paste. The starch composition was prepared by placing 25 grams of the product of Example 1 into a 250 ml beaker. Thereafter 75 grams of the product of Example 2 was placed into the beaker. The contents of the beaker were stirred with a lab stirrer for 5 minutes. The resulting starch paste was evaluated and the results are reported in TABLE 1.

### Example 4

### Starch Composition Comprising 50% Cationic Crosslinked Waxy Corn Starch/50% Cationic Crosslinked Dent Corn Starch

In this example, there was provided a cationic crosslinked starch composition comprising 50% by weight cationic crosslinked waxy corn starch and 50% cationic crosslinked dent corn starch, in the form of a gelatinized starch paste. The starch composition was prepared by placing 50 grams of the product of Example 1 into a 250 ml beaker. Thereafter 50 grams of the product of Example 2 was placed into the beaker. The contents of the beaker were stirred with a lab stirrer for 5 minutes. The resulting starch paste was evaluated and the results are reported in TABLE 1.

### Example 5

### Starch Composition Comprising 25% Cationic Crosslinked Waxy Corn Starch/75% Cationic Crosslinked Dent Corn Starch

In this example, there was provided a cationic crosslinked starch composition comprising 25% by weight cationic crosslinked waxy corn starch and 75% cationic crosslinked dent corn starch, in the form of a gelatinized starch paste. The starch composition was prepared by placing 75 grams of the product of Example 1 into a 250 ml beaker. Thereafter 25 grams of the product of Example 2 was placed into the beaker. The contents of the beaker were stirred with a lab stirrer for 5 minutes. The resulting starch paste was evaluated and the results are reported in TABLE 1.

### Evaluation of Starch Compositions

### Example 6

In this example an evaluation of the paper furnish drainage rate characteristics of the products of Examples 1 through 5 was carried out. The procedure for determining paper furnish drainage rate is described herein, with the following specifications:
Test Stock Consistency—0.53%
Test Stock Composition—36% hardwood, 19% softwood, 25% high ash broke, 13% low ash broke, 6% precipitated calcium carbonate, 1% ground calcium carbonate

In determining the paper furnish drainage rate and retention values for Examples 1, 2, 3, 4, and 5, the test sequence of the DDA was as follows:

| Sequence | Addition (lbs/ton) | Time (Seconds) |
|---|---|---|
| Start rotor | | 45 |
| Starch | As Shown | 30 |
| Silica | 4.2 | 10 |
| Coagulant | 1.3 | 5 |
| Drain | | 0 |

The paper furnish drainage rate and retention values for Examples 1, 2, 3, 4, and 5 are reported in TABLE 1.

TABLE 1
Paper Furnish Drainage Rate

| Starch Paste | Starch Paste | Paper Furnish | Paper Furnish |
|---|---|---|---|
| Products of | Addition | Drainage Rate | Retention |
| Example No. | (lb/ton) | (seconds) | (Turbidity NTU) |
| 1 (Control) | 5 | 15.4 | 93 |
| | 10 | 13.8 | 80 |
| | 15 | 13.5 | 70 |
| | 20 | 12.4 | 65 |
| 2 (Control) | 5 | 14.6 | 110 |
| | 10 | 13.0 | 95 |
| | 15 | 12.2 | 85 |
| | 20 | 11.7 | 79 |
| 3 | 5 | 14.9 | 99 |
| | 10 | 12.7 | 92 |
| | 15 | 12.8 | 83 |
| | 20 | 12.2 | 72 |
| 4 | 5 | 14.7 | 97 |
| | 10 | 12.4 | 88 |
| | 15 | 12.0 | 87 |
| | 20 | 12.7 | 77 |
| 5 | 5 | 15.0 | 95 |
| | 10 | 12.7 | 82 |
| | 15 | 12.4 | 79 |
| | 20 | 12.2 | 72 |

In view of the data in Table 1 it is observed that for a given starch addition, generally, the paper furnish drainage rate, where the compositions of the current disclosure are used, improves as compared with the control. It is expected that the improved paper furnish drainage rate would lead to faster paper machine operation.

### Example 7

### Cationic Waxy Corn Starch Control

In the following examples there was utilized as a control, a cationic waxy corn starch in the form of a gelatinized starch paste for evaluation purposes. In more detail, CHARGE +310 starch, available from Cargill, Incorporated, is a cationic waxy corn starch that has been rendered cationic by treatment of the waxy corn starch with (3-chloro-2-hydroxypropyl)trimethylammonium chloride under alkaline conditions.

In producing the gelatinized starch paste, CHARGE +310 starch was slurried to a level of 5% solids in a 4-liter vessel. The slurry was introduced into a continuous jet cooker system. The slurried CHARGE +310 starch was jet cooked at 2.0 liters per minute at a steam pressure of 125 psi and a temperature of 250° F. Once the starch was cooked, the resulting gelatinized starch paste solution was diluted to 2.0% solids. The cooked starch paste was gently agitated for 30 minutes prior to testing. The CHARGE +310 starch was evaluated for the properties of drainage and retention and the results are reported in TABLE 2.

### Example 8

### Starch Composition Comprising 75% Cationic Crosslinked Waxy Corn Starch/25% Cationic Waxy Corn Starch

In this example there was provided a starch composition comprising 75% of a cationic crosslinked waxy corn starch component and 25% of a cationic waxy corn starch component in the form of a gelatinized paste for evaluation purposes. In more detail, the starch composition was prepared by placing 75 grams of the product of Example 2 into a 250 ml beaker. Thereafter 25 grams of the product of Example 7 was placed into the beaker. The contents of the beaker were stirred with a lab stirrer for 5 minutes. The resulting starch paste composition was evaluated and the results are reported in TABLE 2.

### Example 9

### Starch Composition Comprising 25% Cationic Crosslinked Waxy Corn Starch/75% Cationic Waxy Corn Starch

In this example there was provided a starch composition comprising a cationic crosslinked waxy corn starch component and a cationic waxy corn starch component in the form of a gelatinized paste for evaluation purposes. In more detail, the starch composition was prepared by placing 75 grams of the product of Example 7 into a 250 ml beaker. Thereafter 25 grams of the product of Example 2 was placed into the beaker. The contents of the beaker were stirred with a lab stirrer for 5 minutes. The resulting starch paste composition was evaluated and the results are reported in TABLE 2.

### Example 10

### Starch Composition Comprising 75% Cationic Crosslinked Dent Corn Starch/25% Cationic Waxy Corn Starch

In this example there was provided a starch composition comprising a cationic crosslinked dent corn starch component and a cationic waxy corn starch component in the form of a gelatinized paste for evaluation purposes. In more detail, the starch composition was prepared by placing 75 grams of the product of Example 1 into a 250 ml beaker. Thereafter 25 grams of the product of Example 7 was placed into the beaker. The contents of the beaker were stirred with a lab stirrer for 5 minutes. The resulting starch paste composition was evaluated and the results are reported in TABLE 2.

### Example 11

### Starch Composition Comprising 25% Cationic Crosslinked Dent Corn Starch/75% Cationic Waxy Corn Starch

In this example there was provided a starch composition comprising a cationic crosslinked dent corn starch component and a cationic waxy corn starch component in the form of a gelatinized paste for evaluation purposes. In more detail, the starch composition was prepared by placing 75 grams of the product of Example 7 into a 250 ml beaker. Thereafter 25 grams of the product of Example 1 was placed into the beaker. The contents of the beaker were stirred with a lab stirrer for 5 minutes. The resulting starch paste composition was evaluated and the results are reported in TABLE 2.

### Evaluation of Starch Compositions

### Example 12

In this example an evaluation of the paper furnish drainage rate and Retention characteristics of the products of Examples 7 through 11 was carried out. The procedure for determining paper furnish drainage rate and Retention determination is described herein. The results obtained are reported in the following TABLE 2.

In determining the paper furnish drainage rate and retention values for Examples 7, 8, 9, 10, and 11, the test sequence of the DDA was as follows:

| | Addition (lbs/ton) | |
|---|---|---|
| Start rotor | | 45 |
| Alum | 5 | 30 |
| Starch | As shown | 15 |
| Silica | 2 | 5 |
| Drain | | 0 |

The paper furnish drainage rate and retention values for Examples 7, 8, 9, 10, and 11 are reported in Table 2.

TABLE 2
Paper Furnish Drainage Rate and Retention Values

| Starch Paste | Starch Paste | Paper Furnish | Paper Furnish |
|---|---|---|---|
| Products of | Addition | Drainage Rate | Retention |
| Example No. | (lb/ton) | (seconds) | (Turbidity NTU) |
| 7 (Control) | 5 | 16.8 | 181 |
| | 10 | 17.7 | 178 |
| | 15 | 18.4 | 167 |
| | 20 | 20.4 | 167 |
| 8 | 5 | 14.4 | 147 |
| | 10 | 13.2 | 140 |
| | 15 | 14.2 | 136 |
| | 20 | 14.7 | 138 |
| 9 | 5 | 16.0 | 153 |
| | 10 | 16.3 | 147 |
| | 15 | 16.4 | 148 |
| | 20 | 16.7 | 155 |
| 10 | 5 | 17.5 | 159 |
| | 10 | 16.2 | 155 |
| | 15 | 16.5 | 146 |
| | 20 | 16.8 | 146 |
| 11 | 5 | 16.0 | 182 |
| | 10 | 16.4 | 160 |
| | 15 | 16.0 | 151 |
| | 20 | 17.3 | 142 |

In view of the data in Table 2 it is observed that for a given starch addition, generally, the paper furnish drainage rate, where the compositions of the invention are used, improves as compared with the control. It is expected that the improved paper furnish drainage rate would lead to faster paper machine operation.

The disclosure has been described with reference to various specific and illustrative embodiments and techniques. However, one skilled in the art will recognize that many variations and modifications may be made while remaining within the spirit and scope of the disclosure.

What is claimed is:

1. A composition comprising a cationic crosslinked starch and a starch.

2. The composition according to claim 1 wherein the cationic crosslinked starch is present in an amount of from about 0.01% by weight to about 99.99% by weight, and the starch is present in an amount of from about 0.01% by weight to about 99.99% by weight.

3. The composition according to claim 2 wherein the cationic crosslinked starch is present in an amount of from greater than 5% by weight to about 99.99% by weight and the starch is a second cationic crosslinked starch that is present in an amount of from about 0.01% by weight to about less than 5% by weight.

4. The composition according to claim 1 wherein the cationic crosslinked starch comprises a starch selected from the group consisting of dent corn starch, waxy corn starch, potato starch, wheat starch, rice starch, sago starch, tapioca starch, sorghum starch, sweet potato starch, and mixtures thereof.

5. The composition according to claim 1 wherein the starch of the cationic crosslinked starch is cationized by reaction with a component selected from the group consisting of an amino ion-, imino ion-, sulfonium ion-, phosphonium ion-, ammonium ion-containing compound, and mixtures thereof.

6. The composition according to claim 5 wherein the component is an ammonium ion-containing compound that is a quaternary ammonium ion-containing compound.

7. The composition according to claim 6 wherein the quaternary ammonium ion-containing compound is (3-chloro-2-hydroxypropyl)trimethylammonium chloride.

8. The composition according to claim 1 wherein the starch of the cationic crosslinked starch is crosslinked by reaction with a multi-functional chemical reagent.

9. The composition according to claim 8 wherein the multi-functional chemical reagent is selected from the group consisting of a multi-functional etherifying reagent and a multi-functional esterifying reagent.

10. The composition according to claim 9 wherein the multi-functional chemical reagent is a multi-functional etherifying reagent selected from the group consisting of an organohalide, an organosulfate, an organosulfonate, an organophosphate, an organophosphonate, an organoisocyanate, an organoazide, an aldehyde, a ketone, an epoxide, an alkene, an alkyne, intramolecular mixtures thereof, and mixtures thereof.

11. The composition according to claim 9 wherein the multi-functional chemical reagent is a multi-functional esterifying reagent selected from the group consisting of a carboxylic acid, an anhydride, an ester, an acid halide, a phosphorous oxyhalide, a phosphorous oxyanhydride, a sulfuryl halide, intramolecular mixtures thereof, and mixtures thereof.

12. The composition according to claim 11 wherein the multi-functional esterifying reagent is a phosphorous oxyanhydride that is a metal salt of trimetaphosphate.

13. The composition according to claim 1 wherein the starch of the cationic crosslinked starch is cationized by reaction with a component selected from the group consisting of an amino ion-, imino ion-, sulfonium ion-, phosphonium ion-, ammonium ion-containing compound, and mixtures thereof, and wherein the starch of the cationic crosslinked starch is crosslinked by reaction with a multi-functional chemical reagent.

14. The composition according to claim 13 wherein the component is an ammonium ion-containing compound.

15. The composition according to claim 13 wherein the multi-functional chemical reagent is selected from the group consisting of a multi-functional etherifying reagent and a multi-functional esterifying reagent.

16. The composition according to claim 15 wherein the multi-functional chemical reagent is a multi-functional etherifying reagent selected from the group consisting of an organohalide, an organosulfate, an organosulfonate, an organophosphate, an organophosphonate, an organoisocyanate, an organoazide, an aldehyde, a ketone, an epoxide, an alkene, an alkyne, intramolecular mixtures thereof, and mixtures thereof.

17. The composition according to claim 15 wherein the multi-functional chemical reagent is a multi-functional esterifying reagent selected from the group consisting of a carboxylic acid, an anhydride, an ester, an acid halide, a phosphorous oxyhalide, a phosphorous oxyanhydride, a sulfuryl halide, intramolecular mixtures thereof, and mixtures thereof.

18. The composition according to claim 1 wherein the starch of the cationic crosslinked starch is cationized by reaction with an ammonium ion-containing compound, and wherein the starch of the cationic crosslinked starch is crosslinked by reaction with a phosphorous oxyanhydride.

19. The composition according to claim 18 wherein the ammonium ion-containing compound is (3-chloro-2-hydroxypropyl)trimethylammonium chloride, and the phosphorous oxyanhydride is a metal salt of trimetaphosphate.

20. The composition according to claim 1 wherein the starch is selected from the group consisting of dent corn starch, waxy corn starch, potato starch, wheat starch, rice starch, sago starch, tapioca starch, sorghum starch, sweet potato starch, and mixtures thereof.

21. The composition according to claim 1 wherein the starch is selected from the group consisting of an unmodified starch, a modified starch, and mixtures thereof.

22. The composition according to claim 21 wherein the starch is a modified starch, wherein the modification of the starch is selected from the group consisting of a chemical modification, a physical modification, an enzymatic modification, and mixtures thereof.

23. The composition according to claim 22 wherein the modification of the starch is chemical modification.

24. The composition according to claim 23 wherein the chemical modification of the starch is selected from the group consisting of depolymerization, oxidation, reduction, etherification, esterification, nitrification, defatting, cationization, crosslinking, and mixtures thereof.

25. The composition according to claim 24 wherein the chemical modification is cationization wherein the starch is cationized by reaction of the starch with a component selected from the group consisting of an amino ion-, imino ion-, sulfonium ion-, phosphonium ion-, ammonium ion-containing compound, and mixtures thereof.

26. The composition according to claim 24 wherein the chemical modification is crosslinking wherein the starch is crosslinked by reaction with a multi-functional chemical reagent.

27. The composition according to claim 22 wherein the modification of the starch is physical modification.

28. The composition according to claim 27 wherein the physical modification of the starch is selected from the group consisting of thermal treatment, fracturing by mechanical means, pressure treatment, and mixtures thereof.

29. The composition according to claim 28 wherein the physical modification is pressure treatment wherein the pressure treatment of the starch is extrusion.

30. The composition according to claim 28 wherein the physical modification of the starch is a thermal treatment of the starch.

31. The composition according to claim 22 wherein the modification of the starch is enzymatic modification.

32. The composition according to claim 31 wherein the enzymatic modification of the starch is selected from the group consisting of reaction of starch with an alpha amylase enzyme, reaction of starch with a protease enzyme, reaction of starch with a lipase enzyme, reaction of starch with a phosphorylase enzyme, reaction of starch with an oxidase enzyme, and mixtures thereof.

33. The composition according to claim 1 wherein the starch of the cationic crosslinked starch is cationized by reaction with a component selected from the group consisting of an amino ion-, imino ion-, sulfonium ion-, phosphonium ion-, ammonium ion-containing compound, and mixtures thereof, and wherein the starch of the cationic crosslinked starch is crosslinked by reaction with a multi-functional chemical reagent selected from the group consisting of a multi-functional etherifying reagent and a multi-functional esterifying reagent, and the starch is a starch modified by a modification selected from the group consisting of chemical modification, physical modification, enzymatic modification, and mixtures thereof.

34. The composition according to claim 1 wherein the starch is a second cationic crosslinked starch, wherein the cationic crosslinked starch is different from the second cationic crosslinked starch.

35. The composition according to claim 34 wherein the cationic crosslinked starch is a starch cationized with (3-chloro-2-hydroxypropyl)trimethylammonium chloride, and crosslinked with a metal salt of trimetaphosphate that is sodium trimetaphosphate, and the second cationic crosslinked starch is a starch cationized with (3-chloro-2-hydroxypropyl)trimethylammonium chloride and crosslinked with a metal salt of trimetaphosphate that is sodium trimetaphosphate, wherein the cationic crosslinked starch is different from the second cationic crosslinked starch.

36. The composition according to claim 1 wherein the starch is a cationic starch.

37. The composition according to claim 36 wherein the cationic crosslinked starch is a starch cationized with (3-chloro-2-hydroxypropyl)trimethylammonium chloride, and crosslinked with a metal salt of trimetaphosphate, and the starch is a starch cationized with (3-chloro-2-hydroxypropyl)trimethylammonium chloride.

38. A cellulosic web product comprising a cellulosic web and a composition comprising a cationic crosslinked starch and a starch.

39. The cellulosic web product according to claim 38 wherein the cationic crosslinked starch is present in an amount of from about 0.01% by weight to about 99.99% by weight, and the starch is present in an amount of from about 0.01% by weight to about 99.99% by weight.

40. The cellulosic web product according to claim 38 wherein the starch of the cationic crosslinked starch is cationized by reaction with a component selected from the group consisting of an amino ion-, imino ion-, sulfonium ion-, phosphonium ion-, ammonium ion-containing compound, and mixtures thereof.

41. The cellulosic web product according to claim 38 wherein the starch of the cationic crosslinked starch is crosslinked by reaction with a multi-functional chemical reagent.

42. The cellulosic web product according to claim 41 wherein the multi-functional chemical reagent is selected from the group consisting of a multi-functional etherifying reagent, a multi-functional esterifying reagent, and mixtures thereof.

43. The cellulosic web product according to claim 38 wherein the starch is selected from the group consisting of unmodified starch, modified starch, and mixtures thereof.

44. The cellulosic web product according to claim 43 wherein the starch is a modified starch wherein the modification is selected from the group consisting of a chemical modification, a physical modification, an enzymatic modification, and mixtures thereof.

45. The cellulosic web product according to claim 44 wherein the starch is cationized and crosslinked.

46. The cellulosic web product according to claim 38 wherein the composition is present in an amount ranging from about 0.1% to about 5% by weight based on cellulosic fiber.

47. The cellulosic web product according to claim 38 wherein the cellulosic web is selected from the group consisting of paper and paperboard.

48. A process for preparing a cellulosic web product comprising incorporating into a cellulosic web a composition comprising a cationic crosslinked starch and a starch.

49. The process according to claim 48 wherein the composition is incorporated in an amount ranging from about 0.1% to about 5% by weight based on cellulosic fiber.

50. A coating composition comprising a pigment and a composition comprising a cationic crosslinked starch and a starch.

51. The coating composition according to claim 50 wherein the composition is present in an amount of from about 1 to about 50 parts based on the pigment.

52. The coating composition according to claim 50 wherein the cationic crosslinked starch of the composition is different from the starch of the composition.

53. A cellulosic web product comprising a cellulosic web coated with the coating composition according to claim 50.

54. A paint comprising the coating composition according to claim 50.

55. A process for producing the composition according to claim 1 comprising mixing components of the composition, heating the resultant mixture to form a gelatinized cationic crosslinked starch paste mixture, in which the starch is gelatinized, and drying the resultant gelatinized starch paste mixture.

56. A process for producing the composition according to claim 1 comprising forming a gelatinized starch paste of each of the components of the composition, mixing the starch paste components, and drying the resultant gelatinized starch paste mixture.
